(19) United States
(12) Patent Application Publication
(10) Pub. No.: US 2025/0356593 A1
(43) Pub. Date: Nov. 20, 2025

(54) METHOD AND APPARATUS FOR THREE-DIMENSIONAL HUMAN-BODY MODEL ESTIMATION AND REFINEMENT

(71) Applicant: QUALCOMM Incorporated, San Diego, CA (US)

(72) Inventors: Junkang ZHANG, San Diego, CA (US); Lei WANG, San Diego, CA (US); Peng LIU, San Diego, CA (US); Kunyao CHEN, San Diego, CA (US); Ning BI, San Diego, CA (US)

(21) Appl. No.: 18/669,132

(22) Filed: May 20, 2024

(51) Int. Cl. G06T 19/00; G06T 7/70

(52) U.S. Cl. CPC G06T 19/00; G06T 7/70; G06T 2207/20044

(57) ABSTRACT

Systems and techniques are described herein for human-body-model shape modification. For instance, a method for human-body-model shape modification is provided. The method may include obtaining a three-dimensional (3D) model of a body of a person; obtaining body pixels based on an image of the body of the person; generating projected body points by projecting points of the 3D model into an image plane; determining a body-point loss based on a comparison of the body pixels and the projected body points; and modifying the 3D model based on the body-point loss to generate a first modified 3D model.

### TECHNICAL FIELD

The present disclosure generally relates to three-dimensional modeling. For example, aspects of the present disclosure include systems and techniques for refining a three-dimensional model of a human body.

### BACKGROUND

Human body-shape estimation is an important task for many applications, including, for example, extended reality (XR) (which may include virtual reality (VR), augmented reality (AR) and/or mixed reality (MR)), medical measurements, and virtual try-on. In order to present high-fidelity three-dimensional (3D) models of bodies of people, conventional modeling techniques enroll accurate body shapes and reconstruct the body shapes in metaverse.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for human-body-model shape modification. According to at least one example, a method is provided for human-body-model shape modification. The method includes: obtaining a three-dimensional (3D) model of a body of a person; obtaining body pixels based on an image of the body of the person; generating projected body points by projecting points of the 3D model into an image plane; determining a body-point loss based on a comparison of the body pixels and the projected body points; and modifying the 3D model based on the body-point loss to generate a first modified 3D model.

In another example, an apparatus for human-body-model shape modification is provided that includes at least one memory and at least one processor (e.g., configured in circuitry) coupled to the at least one memory. The at least one processor configured to: obtain a three-dimensional (3D) model of a body of a person; obtain body pixels based on an image of the body of the person; generate projected body points by projecting points of the 3D model into an image plane; determine a body-point loss based on a comparison of the body pixels and the projected body points; and modify the 3D model based on the body-point loss to generate a first modified 3D model.

In another example, a non-transitory computer-readable medium is provided that has stored thereon instructions that, when executed by one or more processors, cause the one or more processors to: obtain a three-dimensional (3D) model of a body of a person; obtain body pixels based on an image of the body of the person; generate projected body points by projecting points of the 3D model into an image plane; determine a body-point loss based on a comparison of the body pixels and the projected body points; and modify the 3D model based on the body-point loss to generate a first modified 3D model.

In another example, an apparatus for human-body-model shape modification is provided. The apparatus includes: means for obtaining a three-dimensional (3D) model of a body of a person; means for obtaining body pixels based on an image of the body of the person; means for generating projected body points by projecting points of the 3D model into an image plane; means for determining a body-point loss based on a comparison of the body pixels and the projected body points; and means for modifying the 3D model based on the body-point loss to generate a first modified 3D model.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 includes a representation of a rendered 3D body model overlaid with an image of a person;

FIG. 2 is a diagram illustrating an example system for generating a 3D model of a body of a person based on an image of the person, according to various aspects of the present disclosure;

FIG. 3 is a diagram illustrating another example system for generating 3D model of a body of a person based on image of the person, according to various aspects of the present disclosure;

FIG. 4 is a diagram illustrating another example system for generating 3D model of a body of a person based on image of the person, according to various aspects of the present disclosure;

FIG. 5 is a diagram illustrating an example implementation of a stage of the modifier of FIG. 4, according to various aspects of the present disclosure;

FIG. 6 includes an image of a body of a person and a representation of a projection of the body of the person, according to various aspects of the present disclosure;

FIG. 7 is a diagram illustrating an example implementation of a stage of the modifier of FIG. 4, according to various aspects of the present disclosure;

FIG. 8 includes three representations of segments of images of a body of a person, according to various aspects of the present disclosure;

FIG. 9 includes two representations of pixels of an image and projected vertices to describe principles related to silhouette loss, according to various aspects of the present disclosure;

FIG. 10 is a diagram illustrating an example implementation of a stage of the modifier of FIG. 4, according to various aspects of the present disclosure;

FIG. 11 includes two representations of 3D data to describe principles related to 3D loss, according to various aspects of the present disclosure;

FIG. 12 is a flow diagram illustrating an example process for modifying a 3D body model, in accordance with aspects of the present disclosure;

FIG. 13 is a flow diagram illustrating another example process for modifying a 3D body model, in accordance with aspects of the present disclosure;

FIG. 14 is a flow diagram illustrating another example process for modifying a 3D body model, in accordance with aspects of the present disclosure;

FIG. 15 is a block diagram illustrating an example of a deep learning neural network that can be used to perform various tasks, according to some aspects of the disclosed technology;

FIG. 16 is a block diagram illustrating an example of a convolutional neural network (CNN), according to various aspects of the present disclosure; and

FIG. 17 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Human body-shape estimation is an important task for many applications, including, for example, extended reality (XR) (which may include virtual reality (VR), augmented reality (AR) and/or mixed reality (MR)), medical measurements, and virtual try-on (e.g., simulating putting clothing on a body). Human body-shape estimation may also serve as a good initial estimate for other computer vision tasks, such as 3D clothed-body reconstruction from 2D images. However, most 3D scanning sensors are expensive and difficult to access for many users. On the other hand, cameras are accessible sensor for body enrollment.

Systems, apparatuses, methods (also referred to as processes), and computer-readable media (collectively referred to herein as “systems and techniques”) are described herein for estimating body shapes based on images. For example, the systems and techniques may estimate a body shape based on an image from a camera. According to some aspects, the systems and techniques may include a multi-stage estimation and optimization pipeline to estimate body shape based on the image. In some cases, the systems and techniques may obtain an initial estimate of body shape, pose, and translation from a pre-trained 3D-model-estimation network (e.g., Skinned Multi-Person Linear (SMPL)-model-estimation network) based on the image. Obtaining the initial estimate may be optional because some 3D-model-estimation networks of this kind cannot estimate accurate body shapes due to lack of true ground-truths in training data. Nevertheless, such 3D-model-estimation networks can provide a good initial estimate of body pose which may accelerate the following stages.

The systems and techniques may iteratively optimize the SMPL parameters based on multiple two-dimensional (2D) image cues, including but not limited to 2D body joints/hand joints/facial landmarks, body and skin segmentation masks/silhouettes, monocular body depths/normals, etc. The corresponding 3D body information can be projected onto the 2D image. Disparities between the projected 3D body information and the 2D image cues may be iteratively decreased through gradient descent.

The 2D cues may be predicted by multiple pre-trained 2D-estimation networks for respective tasks. The 2D cues may be used as pseudo ground-truth in body optimization. Since each of the 2D networks are trained on large-scale datasets from multiple sources with true ground-truths, the 2D networks can provide more reliable cues for body shape estimation.

To conserve computational resources, (for example, to improve use on mobile devices), the body optimization tasks may be divided into stages. The body-optimization stages may be arranged in a coarse-to-fine optimization process to accelerate the process. Generally, loss functions that require less computation can be included in earlier stages, while those require more computations may be included in later stages. For example, 2D joint/landmark loss may be used to roughly align the 3D model (e.g., the SMPL mesh) with the 2D image of the body. The 2D joint/landmark loss may cause a few mesh vertices need to be reconstructed. Later in the pipeline, body segmentation/silhouette cues may be used to expand/shrink the 3D body shape in the dimension of imaging plane, where the complete body mesh may be computed. Later still in the pipeline, body depth/normal cues may be used to correct body-shape errors not seen by previous steps (e.g. large belly shape in front body view), where rasterization is further needed.

Various aspects of the application will be described with respect to the figures below.

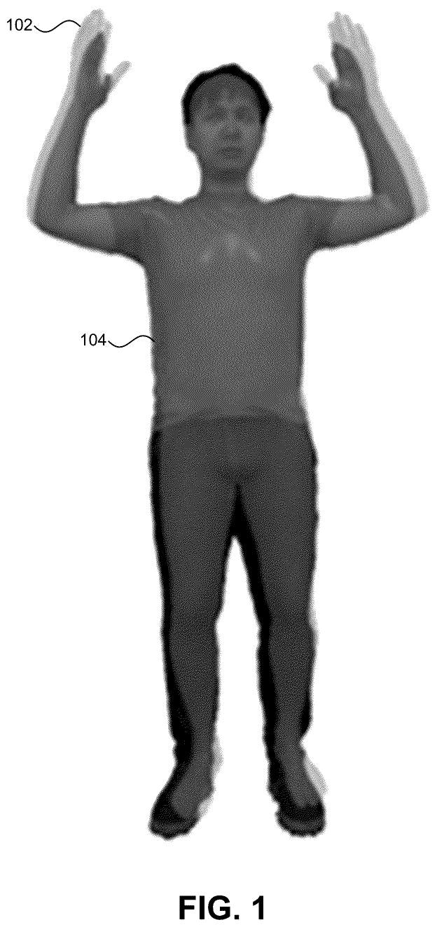

FIG. 1 includes a representation of a rendered 3D body model 102 overlaid with an image 104 of a person. Rendered 3D body model 102 may be, as an example, a rendering of a Skinned Multi-Person Linear (SMPL) model.

A parametric 3D body model (e.g. SMPL) may represent an unclothed/naked body. The 3D body mesh can be reconstructed as:

$$V , J = {F}_{smpl} ( β , θ , t ) ,$$

where V is the 3D mesh vertices, J is 3D body joints and landmarks, β controls 3D body shape, θ controls body pose, t is a global translation vector, and Fₛₘₚₗ is the reconstruction process with pre-trained coefficient bases.

Given a monocular 2D image capturing the full body of a user (e.g., image 104), the systems and techniques may estimate a shape of the body (β). For example, the systems and techniques may estimate the parametric 3D body model rendered as rendered 3D body model 102. Since there is no restriction for the user's pose or location, the systems and techniques may estimate body shape β, body pose θ, and translation t simultaneously. The reconstructed 3D body, projected onto an image plane, should overlap with the image of the body. For example, rendered 3D body model 102 and image 104 should align.

The 3D-to-2D-projection function can be written as:

$$v = {F}_{project} ( V , Cam ) ,$$

$$j = {F}_{project} ( J , Cam ) ,$$

where v and j are projected 2D vertices and joints landmarks respectively, Cam is camera parameters including rotation R_{cam}, translation t_{cam}, and intrinsic parameters. Since rotation and translation are covered by body pose θ and body translation t, camera rotation can be set as an identity matrix and translation as a zero vector. Additionally, intrinsics can be derived from camera-hardware information.

The 3D-to-2D-projection function can be further extended to the estimation from an image sequence (e.g., sequential image frames of video data). For example, the same body shape may be estimated along with image-wise poses and translations across multiple image frames. Estimating the body shape based on multiple image frames may generate a more accurate body shape.

Estimating a body pose of a person can be improved according to the following conditions: (1) the person wears minimal/tight/slim clothes; (2) if using single image, the person stands still while spreading arms and hands, with the front of the body of the person facing straight at the camera; (3) if using a sequence of images, the person stands still, or moves slowly in a standing posture; (4) the camera position is fixed or moving slowly around the subject (e.g. held by a second person), while the imaging plane remains roughly parallel to the body; (5) only one person is present in the frame.

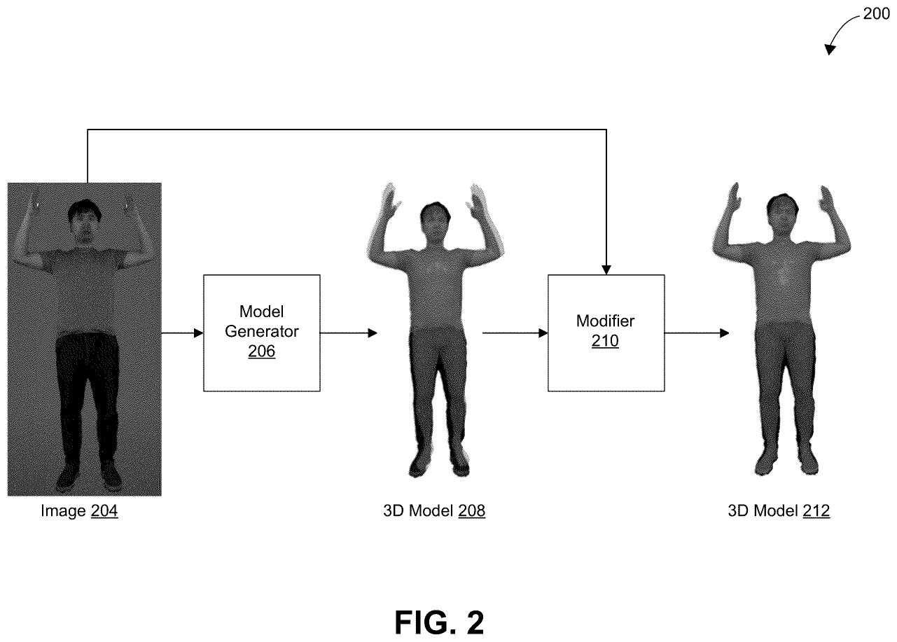

FIG. 2 is a diagram illustrating an example system 200 for generating a 3D model 212 of a body of a person based on an image 204 of the person, according to various aspects of the present disclosure. In general, system 200 may obtain image 204 and use a model generator 206 to generate a 3D model 208 based on image 204. A modifier 210 of system 200 may modify (e.g., to improve) 3D model 208 based on image 204 to generate 3D model 212.

Image 204 may be any image of the body of the person in any pose. Alternatively, image 204 may be of the person in a predetermined pose. Image 204 may include any background and/or may include additional people. In some aspects, image 204 may be selected from among a plurality of images (for example, from a plurality of image frames of video data).

Model generator 206 may be, or may include, a machine-learning model trained to generate 3D models based on images. In some aspects, 3D model 208 may be, for example, an SMPL model of the body of the person. In such aspects, model generator 206 may be trained to generate SMPL models based on images.

In some aspects, modifier 210 may be, or may include, a multi-stage estimation and/or optimization pipeline to estimate body shape (e.g., of 3D model 212) based on 3D model 208 and image 204. 3D model 208 and 3D model 212 are illustrated as rendered and overlaid with image 204 to illustrate a correspondence between the rendered 3D model and image 204. 3D model 212 more closely aligns with image 204 than 3D model 208 aligns with image 204 based on modifier 210 having modified 3D model 208 based on image 204.

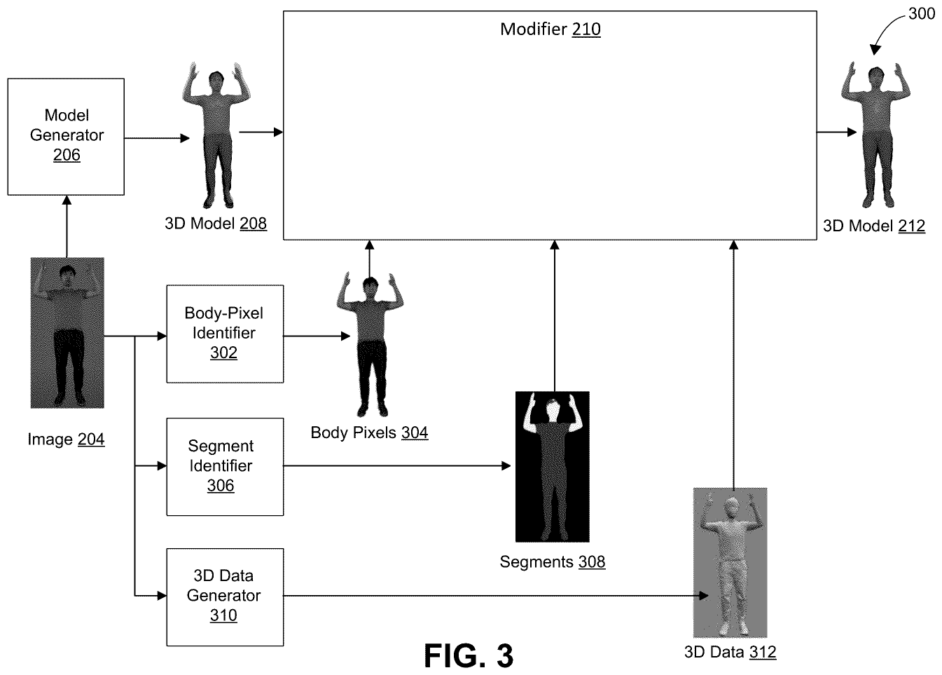

FIG. 3 is a diagram illustrating an example system 300 for generating 3D model 212 of a body of a person based on image 204 of the person, according to various aspects of the present disclosure. In general, system 300 may obtain image 204 and use model generator 206 to generate 3D model 208 based on image 204. Modifier 210 may modify (e.g., to improve) 3D model 208 based on data based on image 204 to generate 3D model 212.

System 300 may include one or more of a body-pixel identifier 302 to generate body pixels 304, a segment identifier 306 to generate segments 308, and a 3D data generator 310 to generate 3D data 312. Modifier 210 may generate 3D model 212 based on 3D model 208 and based on one or more of body pixels 304, segments 308, and 3D data 312.

Body-pixel identifier 302 may obtain or generate body pixels 304 based on image 204. For example, according to some aspects, body-pixel identifier 302 may be, or may include, a machine-learning model trained to identify body pixels of images. Body pixels 304 may be pixels of image 204 that relate to points of the body of the person.

Body pixels 304 may be, or may include, pixels that represent parts of the body of the person. In some aspects, body pixels 304 may be joint pixels indicative of pixels representing joints of the body of the person. For example, body pixels 304 may include a pixel representative of each of: toes, feet, ankles, knees, hips, one or more points of a back, one or more points of a neck, shoulders, elbows, wrists, hands, fingers, etc. In some aspects, body pixels 304 may be landmarks indicative of landmarks of the body of the person. For example, body pixels 304 may include pixels representative facial landmarks, for example, corners of eyes, centers of eyes, a bridge of the nose, nostrils, lips, etc.

Segment identifier 306 may generate segments 308 based on image 204. Segment identifier 306 may be, or may include, a machine-learning model trained to identify segments of images. For example, segment identifier 306 may be, or may include, an image-segmentation network. Segment identifier 306 may identify pixels that represent the body of the person as compared with pixels that do not represent the body of the person (e.g., background pixels). In some aspects, segment identifier 306 may differentiate between skin, hair, and clothing of the person.

Segments 308 may be, or may include, an indication of segments of image 204 identified by segment identifier 306. In some aspects, segments 308 may include a segmentation map that may identify each pixel of image 204 as either representative of the body of the person, or not. Additionally or alternatively, the segmentation map may include labels, for example, identifying pixels as skin, clothing, hair, or background.

In some aspects, segments 308 may be, or may include, a silhouette. For example, rather than segments 308 being a segmentation map including a label for each pixel of image 204, segments 308 may include a silhouette of segments of such a segmentation map. For instance, segments 308 may include edges of a segmentation map. A silhouette may be smaller, in data size, and/or may be less computationally expensive to process (e.g., at modifier 210).

3D data generator 310 may generate 3D data 312 based on image 204. 3D data generator 310 may be, or may include, a machine-learning model trained to generate 3D data based on images. For example, 3D data generator 310 may be, or may include, a monocular-depth-determination network.

3D data 312 may be, or may include, data regarding a third spatial dimension. In some aspects, 3D data 312 may be, or may include, depth data. For example, 3D data 312 may include depth values for various pixels of image 204. For instance, 3D data 312 may include a depth value for each pixel of image 204 that represent the body of the person. Depth values may represent a distance between a camera which captured image 204 and various points of the person.

In some aspects, 3D data 312 may be, or may include, normals. For example, 3D data 312 may include vectors for various pixels of image 204. For instance, 3D data 312 may include a vector for each pixel of image 204 that represent the body of the person. The vectors may be normal vectors, for example, perpendicular to a surface of the body of the person.

In some aspects, image 204 may be selected from among a plurality of images (for example, from a plurality of image frames of video data) based on a pose of the body of the person in image 204. For example, one or more of body-pixel identifier 302, segment identifier 306, and 3D data generator 310 may perform better using images of bodies in certain body poses than using images of bodies in other body poses. As such, image 204 may be selected based on a pose so that one or more of body-pixel identifier 302, segment identifier 306, and 3D data generator 310 may generate good results. For example, images capturing a body from the side may include occlusions and may thus be unsuitable for body pose estimation. For example, body-pixel identifier 302, segment identifier 306, and/or 3D data generator 310 may generate low confidence scores based on images viewing a body from the side. Therefore, images capturing the body from the front may be preferred over images capturing the body from the side.

In some aspects, system 200 may adjust 3D model 208 based on multiple images (e.g., multiple instances of image 204). For example, system 200 may iteratively improve a body shape (e.g., β of a SMPL model) using multiple images. For example, after generating an instance of 3D model 212 based on a first image, a body shape (B) of the instance of 3D model 212 may be used in place of the body shape of 3D model 208 when repeating the operations of system 300 using a second instance of image 204 (e.g., a second image).

Additionally or alternatively, in some aspects, system 200 may adjust (e.g., simultaneously or substantially simultaneously) multiple instances of 3D model 208 based on multiple instances of image 204 of a same person. For example, there may be multiple instances of image 204 and multiple instances of system 200. Each of the instances of system 200 may operate on a respective instance of image 204 (e.g., at the same time or substantially the same time). In such cases, each corresponding instance of 3D model 212 generated by a respective instance of system 200 may have its own (image-wise) body pose (θ) and body translation (t) while all instances of 3D model 212 may share the same body shape (β).

Additionally temporal constraints can be added to improve the results. For example, for any three continuous frames being optimized, the 3D SMPL vertex/joint locations of the second frame can be constrained by penalizing their distances to their corresponding locations in both its previous and following frames.

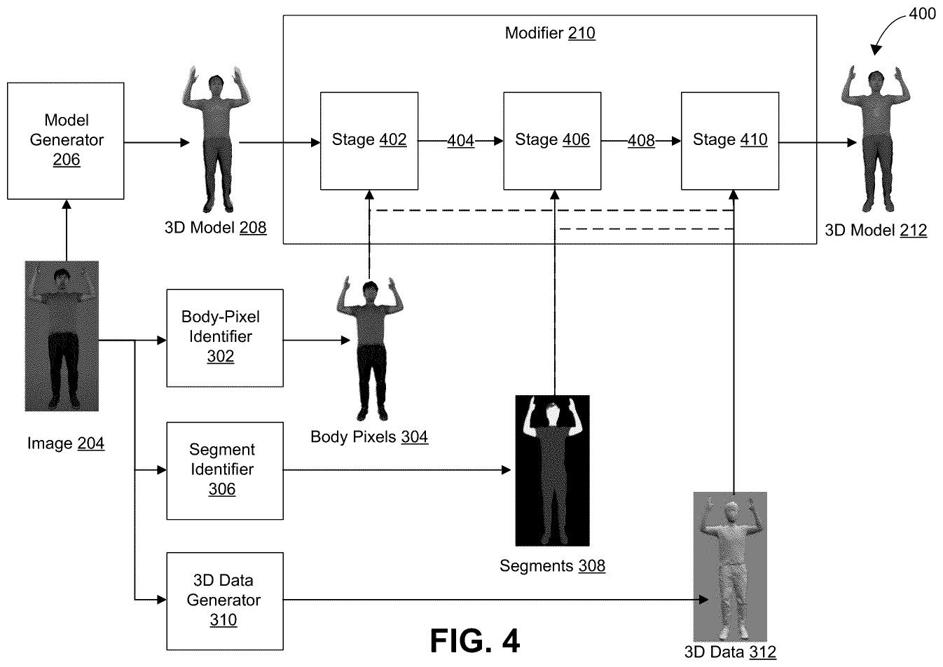

FIG. 4 is a diagram illustrating an example system 400 for generating 3D model 212 of a body of a person based on image 204 of the person, according to various aspects of the present disclosure. In general, system 400 may obtain image 204 and use model generator 206 to generate 3D model 208 based on image 204. Modifier 210 may modify (e.g., to improve) 3D model 208 based on one or more of body pixels 304, segments 308, and 3D data 312 to generate 3D model 212.

Modifier 210 may be, or may include, a multi-stage estimation and/or optimization pipeline to estimate body shape (e.g., of 3D model 212) based on body pixels 304, segments 308, and/or 3D data 312. For example, modifier 210 may adjust 3D model 208 at a first stage-stage 402 to generate a first refined 3D model-modified 3D model 404, then adjust modified 3D model 404 at a second stage-stage 406 to generate a second refined 3D model-modified 3D model 408, then adjust modified 3D model 408 at a third stage-stage 410 to generate a third refined 3D model-3D model 212.

In some aspects, at stage 402, modifier 210 may adjust 3D model 208 based on body pixels 304. Further, at stage 406, modifier 210 may adjust modified 3D model 404 based on segments 308. Further, at stage 410, modifier 210 may adjust modified 3D model 408 based on 3D data 312.

In some aspects, at stage 402, modifier 210 may adjust 3D model 208 based on body pixels 304. Further, at stage 406, modifier 210 may adjust modified 3D model 404 based on segments 308 and body pixels 304. Further, at stage 410, modifier 210 may adjust modified 3D model 408 based on 3D data 312, segments 308, and body pixels 304.

In some aspects, modifier 210 may include additional or fewer stages than stage 402, stage 406, and stage 410. For example, in some aspects, one or more of stage 402, stage 406, and stage 410 may be omitted. Additionally or alternatively, modifier 210 may include one or more additional stages of modification not illustrated in FIG. 4.

In some aspects, stage 402 may be less computationally expensive (e.g., consume less power and/or take less computational time) than stage 406 and stage 406 may be less computationally expensive than stage 410. When refining 3D model 208 at stage 402, modifier 210 may make relatively large refinements to 3D model 208. As such, modified 3D model 404 may be better than 3D model 208 and may require less refinement (e.g., at stage 406 and stage 410). Further, when refining modified 3D model 404 at stage 406, modifier 210 may make relatively medium refinements to modified 3D model 404. As such modified 3D model 408 may be better than modified 3D model 404 and may require less refinement (e.g., at stage 410). Further, when refining modified 3D model 408 at stage 410, modifier 210 may make relatively small refinements to modified 3D model 408.

By refining 3D model 208 in stages (e.g., at stage 402, stage 406, and stage 410), modifier 210 may conserve computational resources. For example, modifier 210 may make relatively large refinements at stage 402, which may be computationally less expensive than stage 406 and stage 410. Then, modifier 210 may make relatively medium refinements to modified 3D model 404 at stage 406, which may be more computationally expensive than stage 402 but less computationally expensive than stage 410. Then, modifier 210 may make relatively small refinements to modified 3D model 408 at stage 410, which may be more computationally expensive than stage 402 and stage 406. By making relatively large refinements early in the pipeline, using less computationally expensive stages, modifier 210 may leave relatively small refinements to be made by the more computationally expensive stages later in the pipeline. Leaving only small refinements to be made by the more computationally expensive stages may conserve computational resources compared to a hypothetical technique that may make all refinements at the same time.

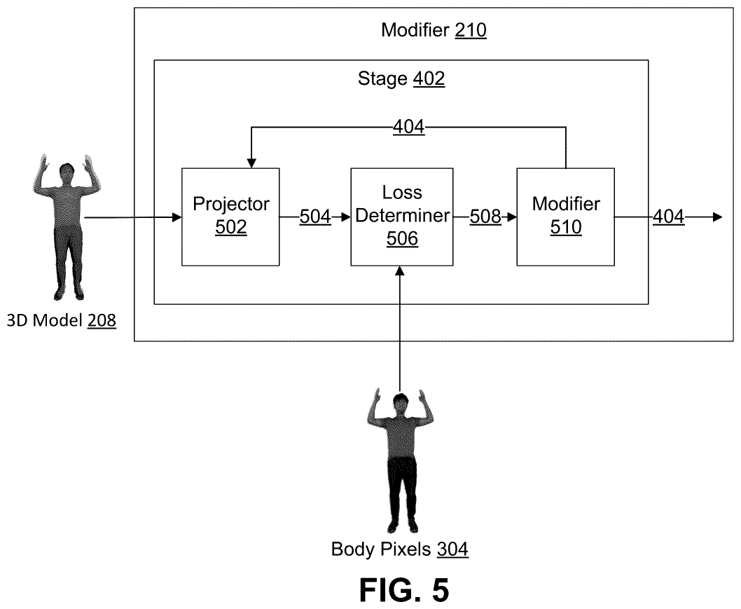

FIG. 5 is a diagram illustrating an example implementation of stage 402 of modifier 210, according to various aspects of the present disclosure. At stage 402, a projector 502 may project body points of 3D model 208 into a 2D image plane to generate projected body points 504. For example, projector 502 may project joints and/or landmarks of 3D model 208 into the 2D image plane to generate projected body points 504. Loss determiner 506 may determine loss 508 based on differences between projected body points 504 and body pixels 304. Modifier 510 may modify 3D model 208 based on loss 508 to generate modified 3D model 404.

Further, stage 402 may implement an iterative process in which, after generating an instance of modified 3D model 404, projector 502 projects body points of the instance of modified 3D model 404 to generate a further instance of projected body points 504. Additionally, loss determiner 506 may determine a further instance of loss 508 based on the further instance of projected body points 504 and body pixels 304 and modifier 510 may further modify the instance of modified 3D model 404 based on the further instance of loss 508 to generate a further instance of modified 3D model 404. Stage 402 may continue the iterative process for predetermined number of cycles or until loss 508 satisfies a threshold.

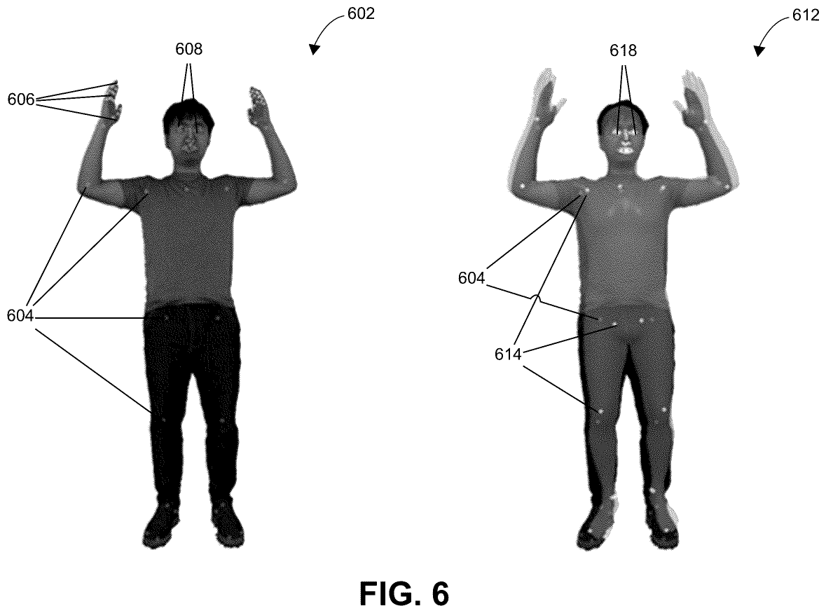

FIG. 6 includes an image 602 of a body of a person and a representation 612 of a projection of the body of the person, according to various aspects of the present disclosure. Image 602 may be an image captured of the person. For example, image 602 may be an example of image 204 of FIG. 2, FIG. 3, FIG. 4 and FIG. 5.

Image 602 is overlaid with joint points 604, hand-joint points 606, and facial landmarks 608. Joint points 604, hand-joint points 606, and/or facial landmarks 608 may be estimated by a 2D-joint-estimation network, such as body-pixel identifier 302 of FIG. 3 and FIG. 4.

Representation 612 may be a projection of a 3D model of the body of the person. For example, representation 612 may be 3D model 208 of FIG. 2, FIG. 3 FIG. 4 and FIG. 5 projected into an image plane corresponding to image 602. For example, representation 612 may be an example of projected body points 504 of FIG. 5. Representation 612 is overlaid with an image of the person. Further, representation 612 is overlaid with projected body-model joint points 614. Body-model joint points 614 may be joint points of the 3D body model (J), projected according to:

$$j = {F}_{project} ( J , Cam )$$

Representation 612 is further overlaid with joint points 604, which were determined based on image 602. There are differences between the position of body-model joint points 614 and corresponding joint points 604. The differences are based on differences between the 3D body model (J) and joint points as determined by the 2D-joint-estimation network.

Additionally, representation 612 is overlaid with body-model landmarks 618. Body-model landmarks 618 may be determined based on the 3D body model or body-model landmarks 618 may be landmarks of the 3D body model. For example, body-model landmarks 618 may be a subset of vertices (V) or a set of 3D points sampled on the body model surface (which may be calculated through predefined barycentric coordinates), projected according to:

$$v = {F}_{project} ( V , Cam ) ,$$

There may be difference between body-model landmarks 618 and facial landmarks 608.

Modifier 210 of FIG. 2, FIG. 3, FIG. 4, and FIG. 5 may determine a loss based on such differences (e.g., the differences between joint points 604 and body-model joint points 614, the differences between facial landmarks 608 and body-model landmarks 618, and the differences between hand-joint points 606 and body-model hand-joints (not depicted in FIG. 6)) and adjust the 3D body model based on the loss. For example, loss determiner 506 of FIG. 5 may determine loss 508 based on the differences and modifier 510 may adjust 3D model 208 (or modified 3D model 404) based on the loss. An example 2D joint/landmark loss can be written as:

$${l}_{joint} = \frac{1}{\sum {c}_{i}} {\sum }_{{j}_{i} ∈ j} {c}_{i} Re lu ( dist ( {j}_{i} , {q}_{i} ) - {Thresh}_{i} )$$

where jᵢ is the pixel location of i-th projected joint, qᵢ and cᵢ>0 are predicted joints location and visibility/confidence value from 2D estimation network.

Since there are network prediction errors as well as the deviation in joint location definition between parametric body model and training data (differences between joint points 604 and body-model joint points 614), a tolerance Threshᵢ≥0 is allowed in calculating the joints loss. The tolerance is usually set larger for body joints and smaller for hand joints and facial landmarks and should be adjusted up-to-scale with regard to body height in the image.

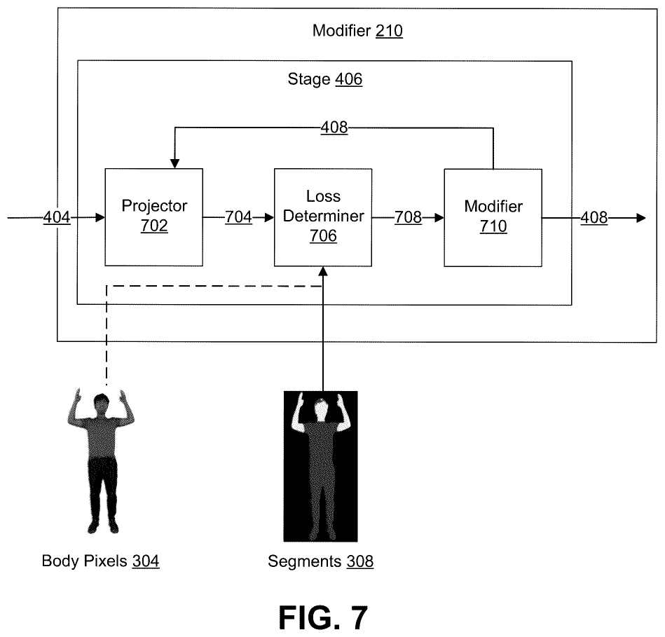

FIG. 7 is a diagram illustrating an example implementation of stage 406 of modifier 210, according to various aspects of the present disclosure. At stage 406, a projector 702 may project vertices of modified 3D model 404 (e.g., output of stage 402 of FIG. 4 and FIG. 5) into a 2D image plane to generate projected vertices 704. Loss determiner 706 may determine loss 708 based on differences between projected vertices 704 and segments 308. Modifier 710 may modify modified 3D model 404 based on loss 708 to generate modified 3D model 408.

Further, stage 406 may implement an iterative process in which, after generating an instance of modified 3D model 408, projector 702 projects vertices of the instance of modified 3D model 408 to generate a further instance of projected vertices 704. Additionally, loss determiner 706 may determine a further instance of loss 708 based on the further instance of projected vertices 704 and segments 308 and modifier 710 may further modify the instance of modified 3D model 408 based on the further instance of loss 708 to generate a further instance of modified 3D model 408. Stage 406 may continue the iterative process for predetermined number of cycles or until loss 708 satisfies a threshold.

In some aspects, loss determiner 706 may additionally determine loss 708 based on projected body pixels and body pixels 304. For example, loss determiner 706 may implement or include loss determiner 506 of FIG. 5 which may determine a loss based on projected body points of modified 3D model 404 (and modified 3D model 408) and body pixels 304 as described with regard to FIG. 6.

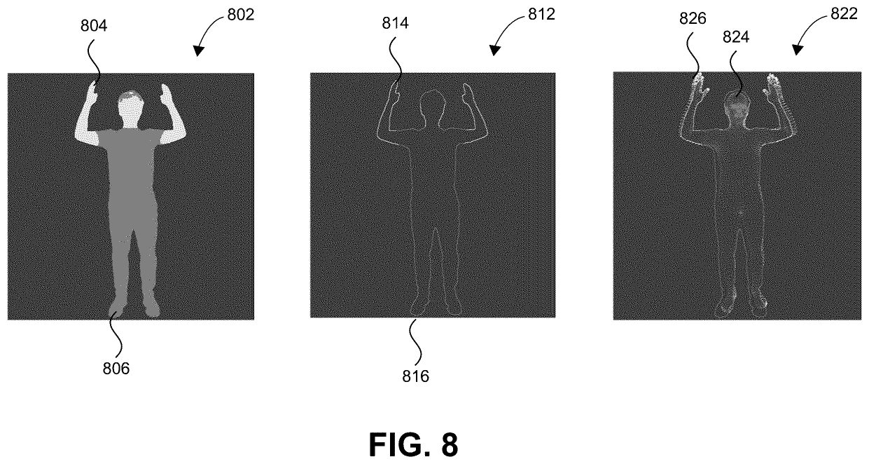

FIG. 8 includes three representations of segments of images of a body of a person, according to various aspects of the present disclosure. Segmentation mask 802 is segmentation mask with clothing pixels 806 of a first shade indicating non-skin pixels of the image and skin pixels 804 of a second shade indicating skin pixels of the image. Silhouette 812 is silhouette of segmentation mask 802 with clothing edge pixels 816 of a first shade indicating non-skin edge pixels of segmentation mask 802 and skin edge pixels 814 of a second shade indicating skin edge pixels of segmentation mask 802. Silhouette 812 may be smaller in data size than segmentation mask 802. In other words, it may be smaller to store silhouette 812 in memory than to store segmentation mask 802. Further, communicating and/or processing silhouette 812 may consume less communication bandwidth and/or processing capacity than communicating and/or processing segmentation mask 802.

Body mesh 822 is a projection of vertices of a 3D body model (e.g., 3D model 208 of FIG. 2, FIG. 3 and FIG. 4 or modified 3D model 404 of FIG. 4, FIG. 5, and FIG. 7). Body mesh 822 is overlaid with silhouette 812. Vertices of body mesh 822 that are within silhouette 812 are represented by a first shade and are referred to as conforming vertices 824 while pixels that are outside silhouette 812 are represented by a second shade and are referred to as nonconforming vertices 826.

In some aspects, modifier 210 of FIG. 2, FIG. 3, and FIG. 4 may use segmentation loss to modify modified 3D model 404. For example, modifier 210 use segmentation loss to optimize body shape and pose of modified 3D model 404. Modifier 210 may render modified 3D model 404 (which may be, or may include, a 3D SMPL mesh) as a 2D mask. Additionally, segment identifier 306 of FIG. 3 and FIG. 4 (which may be, or may include, a pre-trained network) may estimate a body segmentation mask (e.g., segmentation mask 802) based on image 204 of FIG. 3 and FIG. 4. Modifier 210 may sum up the non-overlapping areas between the two masks as the segmentation loss.

However, differentiable rendering of modified 3D model 404 may be computationally expensive. To avoid differentiable rendering of modified 3D model 404, modifier 210 may use a silhouette loss in lieu of a segmentation loss. Instead of comparing dense mask pixels between the two masks (e.g., comparing a rendered mask based on modified 3D model 404 to segmentation mask 802), modifier 210 may minimize the distance between the silhouette of the body segmentation mask (e.g., silhouette 812) and the SMPL mesh's vertices as projected onto the image (e.g., body mesh 822). In this way, modifier 210 may conserve computational resources by avoiding differentiable rendering.

For example, body mesh 822 represents vertices of modified 3D model 404 as projected. Silhouette 812 represents a silhouette of segmentation mask 802. Nonconforming vertices 826 collectively represent distance between the projected vertices and skin pixels 804 (or non-skin pixels 806). Thus, modifier 210 may seek to decrease nonconforming vertices 826 through an iterative process, for example, involving gradient descent.

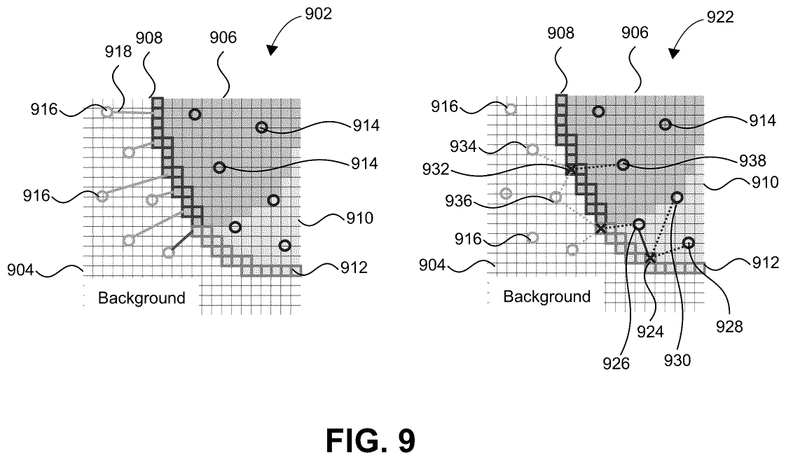

FIG. 9 includes two representations of pixels of an image and projected vertices to describe principles related to silhouette loss, according to various aspects of the present disclosure. FIG. 9 includes representation 902 to illustrate concepts related to a first category of silhouette loss, which is referred to as “reduce loss” and a representation 922 to illustrate concepts related to a second category of silhouette loss, which is referred to as “expand loss.”

Representation 902 and representation 922 both include background pixels 904 of a first shade that represent a background—not the person, skin pixels 906 of a second shade that represent skin of the person, and clothing pixels 910 that represent clothing of the person. Background pixels 904, skin pixels 906, and clothing pixels 910 may be pixels of, or derived from, a segmentation mask, such as segmentation mask 802 of FIG. 8. Representation 902 and representation 922 both include skin edge pixels 908 at an edge between skin pixels 906 and background pixels 904 and clothing edge pixels 912 at an edge between clothing pixels 910 and background pixels 904. Skin edge pixels 908 and clothing edge pixels 912 may be pixels of, or derived from, a silhouette, such as silhouette 812 of FIG. 8.

Representation 902 and representation 922 include conforming vertices 914 and nonconforming vertices 916. Conforming vertices 914 and nonconforming vertices 916 may be vertices of a 3D model (e.g., modified 3D model 404 of FIG. 4) projected onto a 2D image plane. Conforming vertices 914 and nonconforming vertices 916 may be examples of conforming vertices 824 and nonconforming vertices 826 of FIG. 8 respectively.

In representation 902, lines 918 between nonconforming vertices 916 and skin edge pixels 908 (or clothing edge pixels 912) indicate distances between nonconforming vertices 916 and their nearest skin edge pixels 908 (or clothing edge pixels 912). Nonconforming vertices 916, and/or the lengths of lines 918, may be used to determine in the silhouette loss, or more specifically to determine reduce loss.

To determine silhouette loss (both reduce loss and expand loss), the outmost pixels from the body segmentation mask (e.g., segmentation mask 802) are extracted as a silhouette (e.g., silhouette 812). Extracting the silhouette can be achieved in multiple ways. For example, the mask may be subtracted from its morphologically dilated version. As another example, a morphologically eroded version of the mask may be subtracted from the mask. In both examples, a 3×3 kernel may be used in the dilation or erosion operations to get a thin silhouette. When a skin mask is available, pixels of the body silhouette may be labeled as skin or non-skin. For example, a pixel of the body silhouette may be labeled as skin edge pixels 814, if the location of pixel of the body silhouette is in skin pixels 804, or at least one of the eight-neighboring pixels to the pixel of the body silhouette is in skin pixels 804. For example, after traversing all pixels of the body silhouette to label all skin edge pixels 814, all the unlabeled pixels of the body silhouette may be labeled as clothing edge pixels 816.

Given a camera projection matrix and current 3D body model (e.g., an estimation of SMPL body mesh), vertices of the 3D body model are projected onto a 2D image plane. For example, body mesh 822 may be a projection of modified 3D model 404. 2D vertices that lie outside the silhouette are labeled by querying their values in the body segmentation mask. For example, conforming vertices 824 and nonconforming vertices 826 are determined based on silhouette 812 (or segmentation mask 802).

To determine reduce loss, the 2D vertices that lie outside the body silhouette are penalized to fit the 3D body model into the segmentation mask. So, for each nonconforming vertices 916, a nearest body silhouette pixel (e.g., of skin edge pixels 908 and clothing edge pixels 912) is found, and the loss is calculated as a function of their distance (e.g., a length of lines 918).

To determine expand loss, the 3D body model is expanded to avoid over-thin or over-small estimation. So, for each silhouette pixel (e.g., of skin edge pixels 908 and/or clothing edge pixels 912), the top-K nearest 3D body model vertices are found. Further it is determined whether all of top-K nearest 3D body model vertices lie inside the segmentation mask. If the top-K nearest 3D body model vertices lie inside the segmentation mask, the loss is calculated as the average (or sum) of distances between the body silhouette pixel and its top-N (N>=1 and N<=K) nearest 3D body model vertices. Otherwise, the corresponding area should only focus on reduce loss.

For example, when K=3, an example clothing edge pixel 924 may have vertex 926, vertex 928, and vertex 930 as its nearest three vertex neighbors. Vertex 926, vertex 928, and vertex 930 are in ascending order based on their distances to clothing edge pixel 924. Because all of vertex 926, vertex 928, and vertex 930 are within skin edge pixels 908 and clothing edge pixels 912, in other words because all of vertex 926, vertex 928, and vertex 930 are conforming vertices 914, an expand loss may be determined for clothing edge pixel 924.

The expand loss for clothing edge pixel 924 may be calculated as the averaged (or summed) distance between clothing edge pixel 924 and the top-N nearest vertices among vertex 926, vertex 928, and vertex 930—the top-N nearest neighboring vertices of clothing edge pixel 924. For example, when N=1, the expand loss may be calculated as the distance between clothing edge pixel 924 and vertex 926—the nearest neighboring vertex of clothing edge pixel 924. For example, when N=2, the expand loss may be calculated as the averaged (or summed) distance from clothing edge pixel 924 to both vertex 926 and vertex 928—the top-2 nearest neighboring vertices of clothing edge pixel 924. For example, when N=3 (that is, N==K), the expand loss may be calculated as the averaged (or summed) distance from clothing edge pixel 924 to all the vertex 926, vertex 928 and vertex 930.

As an example, an example skin edge pixel 932 may have vertex 934, vertex 936, and vertex 938 as its nearest three vertex neighbors. Because not all of vertex 934, vertex 936, and vertex 938 are within skin edge pixels 908 and clothing edge pixels 912, in other words because vertex 934 and vertex 936 are nonconforming vertices 916, no expand loss may be determined for skin edge pixel 932.

K may be used to determine whether an edge pixel exhibits expand loss. If an edge pixel exhibits expand loss, then the pixel's top-N nearest vertices are used in the expand loss. Using the top N-nearest vertices addresses the case where the number of silhouette pixels is much smaller than body mesh vertices numbers, for example, fitting a 3D body with very dense vertices (e.g. millions of vertices) onto a low-resolution image (which extracts only hundreds of silhouette pixels). In such cases, using the top-N(N>1) conforming vertices in the loss will yield more even (and possibly larger) strengths in expanding the body.

Both the reduce and expand loss can be weighted by skin/non-skin labels on the silhouette pixels. For example, the reduce loss based on lines 918 of a skin edge pixels 908 may be weighted differently than the reduce loss of lines 918 based on clothing edge pixels 912. Additionally or alternatively, the expand loss for skin edge pixels 908 may be weighted differently than the expand loss for clothing edge pixels 912.

Algorithm D1 provides a description of an example implementation of determining reduce loss and expand loss.

Algorithm D1. Silhouette loss

Input: (1) 2D body segmentation mask M_{body}, (2) skin mask Mₛₖᵢₙ, (3) skin weight
w_{reduce-sk} and w_{expand-sk}, (4) SMPL mesh 3D vertices V = Fₛₘₚₗ(β, θ, t), (5) camera
matrix Cam, (6) hyperparameters for expand loss K, N (1 ≤ N ≤ K)
Output: Reduce and Expand losses l_{reduce}, l_{expand}
Find body silhouette pixels (2D coordinates):
p_{body} = {(pₓ₁, p_{y1}), ... , (p_{xN}, p_{yN} )} = where( M_{body} − erode( M_{body}) > 0)
Label skin pixels pₛₖᵢₙ = {(pₓᵢ, p_{yi}) ∈ p_{body}|Mₛₖᵢₙ (pₓᵢ, p_{yi}) == 1}
Project SMPL vertices to 2D image plane: v = {(vₓ₁, v_{y1}), ... , (v_{xM},v_{yM})} =
F_{project}(V, Cam)
Find vertices outside of body mask: vₒᵤₜ = {(vₓᵢ, v_{yi}) ∈ v|M_{body} (vₓᵢ, v_{yi}) == 0}
Initialize l_{reduce} = 0, l_{expand} = 0
For vᵢ ∈ vₒᵤₜ:
----Find nearest silhouette pixel pⱼ ∈ p_{body} to vᵢ: j = argminⱼ dist(vᵢ, pⱼ)
----Skin-weighted: wᵢ = w_{reduce-sk} I f pⱼ ∈ pₛₖᵢₙ Else 1
----l_{reduce} = l_{reduce} + wᵢdist(vᵢ, pⱼ)
l_{reduce} = l_{reduce}/ Σᵢ wᵢ
For pⱼ ∈ p_{body}:
----Find top-K nearest vertices {vᵢ_{ₖ} ∈ v} to pⱼ: {i₁, ... , i_{K}} = argsortᵢ ( dist(pⱼ, vᵢ) ) [1: K]
----I f [symbol] vᵢ ∈ vₒᵤₜ, i = i₁, ... , i_{K}:
---- ----Skin-weighted: wⱼ = w_{expand-sk} I f pⱼ ∈ pₛₖᵢₙ Else 1
---- ----l_{expand} = l_{expand} + wⱼ Σᵢ_{ₙ}₌ᵢ_{₁}_{,...,}ᵢ_{_{N}} dist(pⱼ, vᵢ_{ₙ})
----Else:
---- ----wⱼ = 0
l_{expand} = l_{expand}/(N Σⱼ wⱼ)

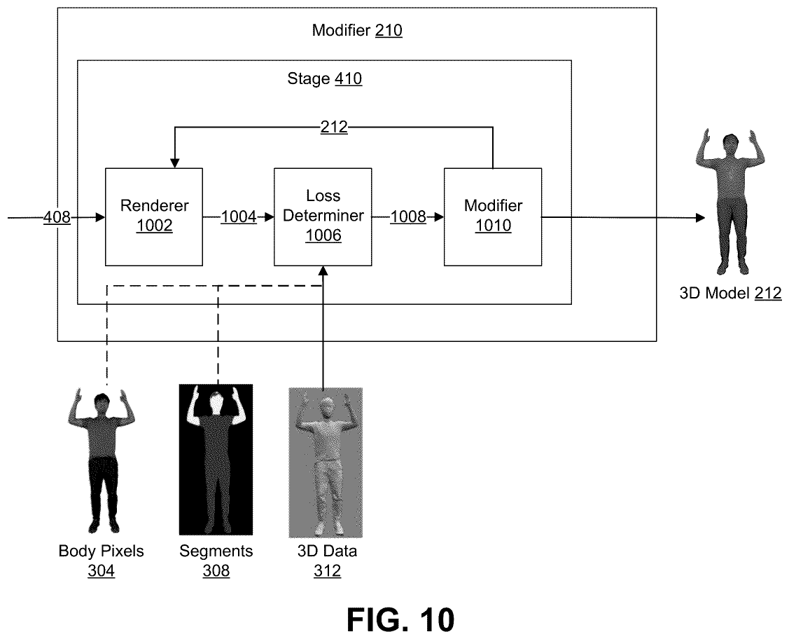

FIG. 10 is a diagram illustrating an example implementation of stage 410 of modifier 210, according to various aspects of the present disclosure. At stage 410, a renderer 1002 may render (e.g., rasterize) modified 3D model 408 (e.g., output of stage 406 of FIG. 4 and FIG. 7) into a 2D image plane to generate rendered 3D body model 1004.

Loss determiner 1006 may determine loss 1008 based on differences between rendered 3D body model 1004 and 3D data 312. Modifier 1010 may modify modified 3D model 408 based on loss 1008 to generate 3D model 212.

Further, stage 410 may implement an iterative process in which, after generating an instance of 3D model 212, renderer 1002 renders the instance of 3D model 212 to generate a further instance of rendered 3D body model 1004. Additionally, loss determiner 1006 may determine a further instance of loss 1008 based on the further instance of rendered 3D body model 1004 and 3D data 312 and modifier 1010 may further modify the instance of 3D model 212 based on the further instance of loss 1008 to generate a further instance of 3D model 212. Stage 410 may continue the iterative process for predetermined number of cycles or until loss 1008 satisfies a threshold.

In some aspects, loss determiner 1006 may additionally determine loss 1008 based on projected body pixels and body pixels 304. For example, loss determiner 1006 may implement or include loss determiner 506 of FIG. 5 which may determine a loss based on projected body points of modified 3D model 408 (and 3D model 212) and body pixels 304 as described with regard to FIG. 6.

In some aspects, loss determiner 1006 may additionally determine loss 1008 based on projected vertices and segments 308. For example, loss determiner 1006 may implement or include loss determiner 706 of FIG. 7 which may determine a loss based on projected vertices of modified 3D model 408 (and 3D model 212) and segments 308 as described with regard to FIG. 8 and FIG. 9.

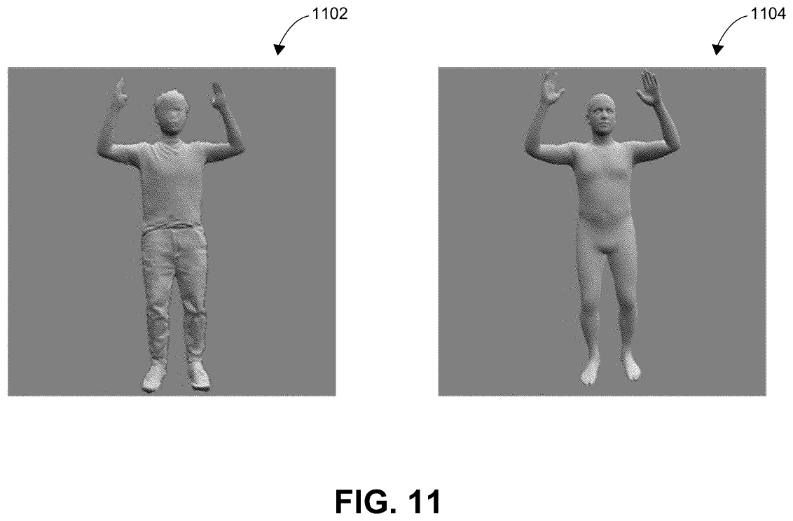

FIG. 11 includes two representations of 3D data to describe principles related to 3D loss, according to various aspects of the present disclosure. Body normal map 1102 is a representation of an example of 3D data generated based on a 2D image of a body of a person. Body normal map 1102 is an example of 3D data 312 of FIG. 3 and FIG. 4. Body normal map 1104 is a representation of a rendering of a 3D body model. Body normal map 1104 is an example of a rendering of modified 3D model 408.

For example, 3D data generator 310 of FIG. 3 and FIG. 4 (which may be, or may include, a monocular depth/normal estimation network) may be used to estimate per-pixel depth/normal values (e.g., 3D data 312) based on image 204. Additionally, modifier 210 may reconstruct modified 3D model 408 and get the per-pixel depth/normal of modified 3D model 408 through rasterization (rendering) in the camera view.

The 3D loss includes of the difference of depth/normal values between the estimated map and the rendering result. Higher weights can be assigned when calculating loss in the skin areas of the image depth/normal map, since the estimated depth/normal on skins should be of higher fidelity due to fewer clothes wrinkles. The rasterization process may be computationally expensive, so 3D loss may be included in later stages (e.g., stage 410) of the optimization pipeline of modifier 210.

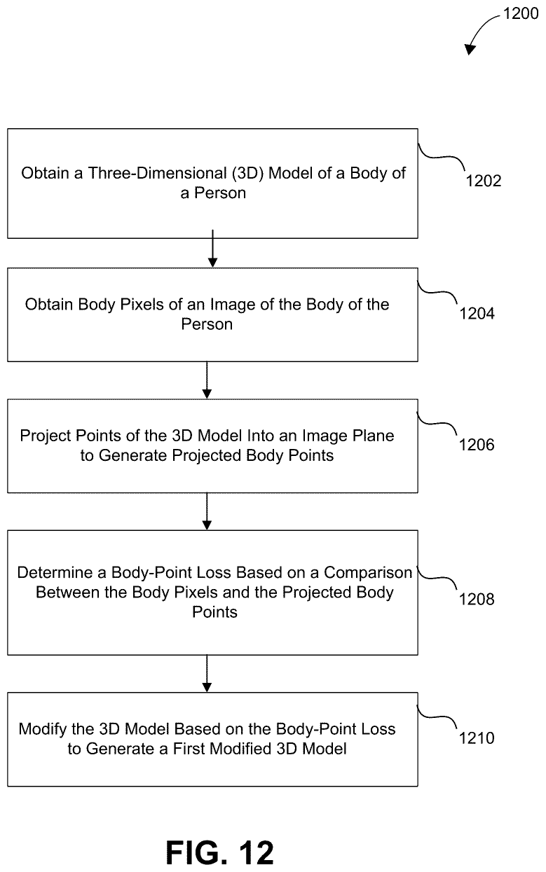

FIG. 12 is a flow diagram illustrating a process 1200 for modifying a 3D model of a body, in accordance with aspects of the present disclosure. One or more operations of process 1200 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1200. The one or more operations of process 1200 may be implemented as software components that are executed and run on one or more processors.

At block 1202, a computing device (or one or more components thereof) may obtain a three-dimensional (3D) model of a body of a person. For example, modifier 210 of FIG. 2, FIG. 3, FIG. 4, FIG. 5, FIG. 7, and FIG. 10 may obtain 3D model 208 of FIG. 2, FIG. 3, FIG. 4, and FIG. 5.

In some aspects, the computing device (or one or more components thereof) may process the image using a machine-learning model to generate the 3D model of the body, wherein the 3D model comprises a Skinned Multi-Person Linear (SMPL) model. For example, model generator 206 of FIG. 2, FIG. 3, and FIG. 4 may generate 3D model 208. 3D body model 208 may be an SMPL model.

At block 1204, the computing device (or one or more components thereof) may obtain body pixels based on an image of the body of the person. For example, modifier 210 may obtain body pixels 304 of FIG. 3, FIG. 4, FIG. 5. FIG. 7, and FIG. 10.

In some aspects, the computing device (or one or more components thereof) may process the image using a machine-learning model to identify the body pixels based on the image. For example, body-pixel identifier 302 of FIG. 3 and FIG. 4 may generate body pixels 304.

In some aspects, the points of the 3D model may be, or may include, joints. The projected body points may be, or may include, projected joint points. The body pixels may be, or may include, joint pixels. For example, 3D model 208 may include joints. Further, projected body points 504 may be, or may include, projected joint points, such as body-model joint points 614. Further, body pixels 304 may be, or may include, joint pixels, such as joint points 604 of FIG. 6.

In some aspects, the points of the 3D model may be, or may include, landmarks. The projected body points may be, or may include, projected landmark points. The body pixels may be, or may include, landmark pixels. For example, 3D model 208 may include landmarks. Further, projected body points 504 may be, or may include, projected landmarks, such as body-model landmarks 618 of FIG. 6. Further, body pixels 304 may be, or may include, landmark pixels, such as facial landmarks 608 of FIG. 6.

At block 1206, the computing device (or one or more components thereof) may generate projected body points by projecting points of the 3D model into an image plane. For example, projector 502 of FIG. 5 may project points of 3D model 208 into an image plane to generate projected body points 504 of FIG. 5 (e.g., body-model joint points 614 of FIG. 6 and/or body-model landmarks 618 of FIG. 6).

At block 1208, the computing device (or one or more components thereof) may determine a body-point loss based on a comparison of the body pixels and the projected body points. For example, loss determiner 506 of FIG. 5 may determine loss 508 determiner 506 based on a comparison of projected body points 504 and body pixels 304.

At block 1210, the computing device (or one or more components thereof) may modify the 3D model based on the body-point loss to generate a first modified 3D model. For example, modifier 510 of FIG. 5 may modify 3D model 208 based on loss 508 to generate 3D model 404 of FIG. 4 and FIG. 5.

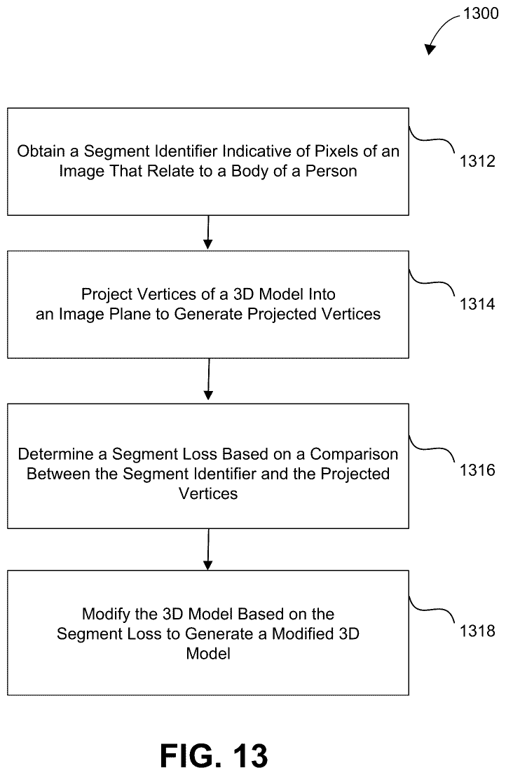

FIG. 13 is a flow diagram illustrating a process 1300 for modifying a 3D model of a body, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1300. The one or more operations of process 1300 may be implemented as software components that are executed and run on one or more processors.

In some aspects, process 1300 may follow process 1200. For example, in such aspects, operations of process 1300 may use outputs of process 1200. In other aspects, process 1200 may follow process 1300. For example, in such aspects, operations of process 1200 may use outputs of process 1300.

At block 1312, a computing device (or one or more components thereof) may obtain a segment identifier indicative of pixels of an image that relate to a body of a person. In some aspects, the image of block 1312 may be the same image as the image of block 1204. For example, modifier 210 may obtain segments 308 of FIG. 3, and FIG. 7. Segments 308 may be based on image 204.

In some aspects, the computing device (or one or more components thereof) may process the image using a machine-learning model to generate the segment identifier. For example, segment identifier 306 of FIG. 3 may generate segments 308 based on image 204.

In some aspects, the segment identifier may be, or may include, a silhouette. For example, the segment identifier may be, or may include, silhouette 812 of FIG. 8. In some aspects, the segment identifier may be, or may include, a segmentation mask. For example, the segment identifier may be, or may include, segmentation mask 802 of FIG. 8.

At block 1314, the computing device (or one or more components thereof) may project vertices of a 3D model into the image plane to generate projected vertices. In some aspects, the 3D model of block 1314 may be the 3D model modified at 1210. For example, projector 702 of FIG. 7 may project vertices of 3D model 404 of FIG. 7 to generate projected vertices 704 of FIG. 7. 3D model 404 may be determined by stage 402 of FIG. 4 and FIG. 5.

At block 1316, the computing device (or one or more components thereof) may determine a segment loss based on a comparison of the segment identifier and the projected vertices. For example, loss determiner 706 of FIG. 7 may determine loss 708 of FIG. 7 based on a comparison of segments 308 and projected vertices 704.

At block 1318, the computing device (or one or more components thereof) may modify the 3D model based on the segment loss to generate a modified 3D model. In some aspects, the 3D model of block 1318 may be the 3D model modified at 1210. For example, modifier 710 of FIG. 7 may modify 3D model 404 based on loss 708 to generate 3D model 408 of FIG. 4 and FIG. 7.

In some aspects, the projected body points may be, or may include, first projected body points. The body-point loss comprises a first body-point loss. The computing device (or one or more components thereof) may project points of the first modified 3D model into the image plane to generate second projected body points; and determine a second body-point loss based on a comparison between the body pixels and the second projected body points, wherein the first modified 3D model is modified based on the segment loss and the second body-point loss. For example, at stage 706, a projector (e.g., projector 702) may project points of 3D model 404 (e.g., body points) to generate projected points. Loss determiner 706 may determine a second body-point loss based on a comparison of body pixels 304 and the projected points. Modifier 710 may modify 3D model 404 based on loss 708 and the second body-point loss to generate 3D model 408.

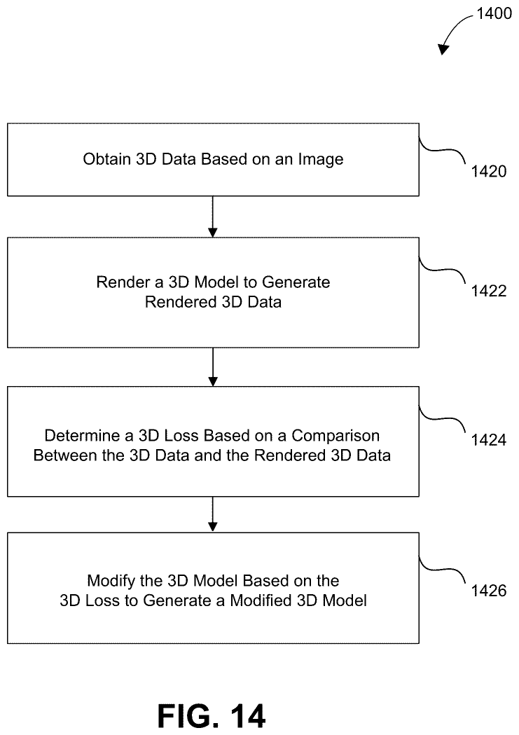

FIG. 14 is a flow diagram illustrating a process 1400 for modifying a 3D model of a body, in accordance with aspects of the present disclosure. One or more operations of process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1400. The one or more operations of process 1400 may be implemented as software components that are executed and run on one or more processors.

In some aspects, process 1400 may follow process 1200 and/or process 1300. For example, in such aspects, operations of process 1400 may use outputs of process 1200 and/or process 1300. In other aspects, process 1200 and/or process 1300 may follow process 1400. For example, in such aspects, operations of process 1200 and/or process 1300 may use outputs of process 1400.

At block 1420, a computing device (or one or more components thereof) may obtain 3D data based on an image. In some aspects, the image of block 1420 may be the same image as the image of block 1204 and/or block 1312. For example, modifier 210 may obtain 3D data 312 of FIG. 3, FIG. 4, and FIG. 10. 3D data 312 may be based on image 204.

In some aspects, the computing device (or one or more components thereof) may process the image using a machine-learning model to generate the 3D data related to the image. For example, d data generator 310 of FIG. 3 may generate 3D data 312 based on image 204.

In some aspects, the 3D data may be, or may include, a depth map comprising distances between a camera which captured the image and points of the body of the person. In some aspects, the 3D data may be, or may include, a normal map comprising normal vectors for points of the body of the person.

At block 1422, the computing device (or one or more components thereof) may render a 3D model to generate rendered 3D data. In some aspects, the 3D model of block 1422 may be the modified 3D model of block 1210 or the modified 3D model of block 1318. For example, renderer 1002 of FIG. 10 may render 3D model 408 to generate 3D body model 1004 of FIG. 10. 3D model 408 may be determined by stage 402 of FIG. 4 and FIG. 5 or by stage 406 of FIG. 4 and FIG. 7.

At block 1424, the computing device (or one or more components thereof) may determine a 3D loss based on a comparison between the 3D data and the rendered 3D data. For example, loss determiner 1006 of FIG. 10 may determine 3D loss 1008 based on a comparison of 3D body model 1004 and 3D data 312.

At block 1426, the computing device (or one or more components thereof) may modify the 3D model based on the 3D loss to generate a modified 3D model. In some aspects, the 3D model of block 1426 may be the modified 3D model of block 1210 or the modified 3D model of block 1318. For example, modifier 1010 may modify 3D model 408 based on 3D loss 1008 to generate 3D model 212. 3D model 408 may be determined by stage 402 of FIG. 4 and FIG. 5 or by stage 406 of FIG. 4 and FIG. 7.

In some aspects, the projected body points may be, or may include, first projected body points. The body-point loss may be, or may include, a first body-point loss. The projected vertices may be, or may include, first projected vertices. The segment loss may be, or may include, a first segment loss. The computing device (or one or more components thereof) may project points of the first modified 3D model into the image plane to generate second projected body points; determine a second body-point loss based on a comparison between the body pixels and the second projected body points, wherein the first modified 3D model is modified based on the segment loss and the second body-point loss; project points of the second modified 3D model into the image plane to generate third projected body points; determine a third body-point loss based on a comparison between the body pixels and the third projected body points; project vertices of the second modified 3D model into the image plane to generate second projected vertices; and determine a second segment loss based on a comparison between the segment identifier and the second projected vertices, wherein the second modified 3D model is modified based on the 3D loss, the third body-point loss, and the second segment loss. For example, at stage 406, a projector (e.g., projector 702) may project body points of 3D model 404 to generate second projected body points. Loss determiner 706 may determine a second body-point loss based on a comparison between the second projected body points and body pixels 304. Further, modifier 710 may modify 3D model 404 based on loss 708 and the second body-point loss. At stage 410, a projector may project body points of 3D model 408 to generate third projected body points. Loss determiner 1006 may determine a third body-point loss based on a comparison between the third projected body points and body pixels 304. Additionally, the projector may project vertices of 3D body model 408 to generate second projected vertices. Loss determiner 1006 may determine a second segment loss based on a comparison between the second projected vertices and segments 308. Modifier 1010 may generate d model 212 based on the third body-point loss, the second segment loss, and loss 1008.

In some aspects, the computing device (or one or more components thereof) may obtain a plurality of images of the body of the person; select the image from among the plurality of images; process the image to generate the 3D model of the body; process the image to identify the body pixels based on the image; process the image to generate the segment identifier; and/or process the image to generate the 3D data related to the image. In some aspects, the computing device (or one or more components thereof) may select the image based on a pose of the person in the image. For example, system 300 of FIG. 3 may obtain a plurality of images, including image 204 and select image 204 from among the plurality of images (e.g., based on a pose of the body in image 204). Model generator 206 may generate 3D body model 208 based on image 204, body-pixel identifier 302 may generate body pixels 304 based on image 204, segment identifier 306 may generate segments 308 based on image 204, and/or 3D data generator 310 may generate 3D data 312 based on image 204.

In some aspects, the computing device (or one or more components thereof) may select a second image from among the plurality of images; and modify the third modified 3D model based on the second image. For example, modifier 210 may repeat at least some of the steps of process 1200, process 1300, and/or process 1400, based on another image. In repeating the steps, modifier 210 may use 3D model 212 (an output of an earlier iteration) as an input rather than 3D model 208.

In some aspects, the computing device (or one or more components thereof) may obtain a plurality of images of the body of the person; select the image from among the plurality of images; modify the 3D model based on the plurality of images. Modifier 210 may modify 3D model 208 based on a plurality of images. In some aspects, the computing device (or one or more components thereof) may modify multiple instances of the 3D model. The multiple instances of the 3D model share a body shape. The multiple instances of the 3D model have respective body poses and respective translations. For example, modifier 210 may modify multiple instances of 3D model 208 independently. In modifying 3D model 208, modifier 210 may modify a body shape of 3D model 208 based on the plurality of images without modifying a pose of 3D model 208 based on the plurality of images.

In some aspects, the 3D model may be modified according to a gradient-descent technique. For example, at block 1210, block 1318, and/or block 1426, the body model may be modified according to a gradient-descent technique.

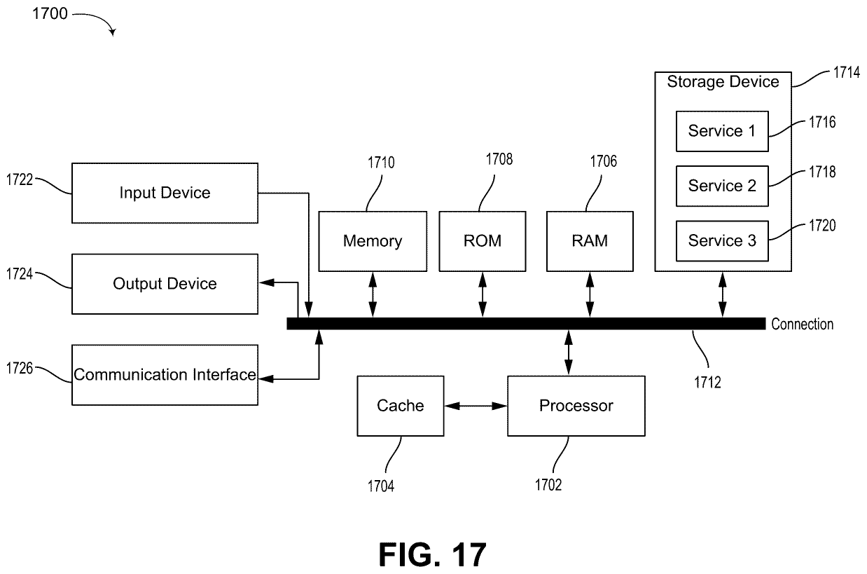

In some examples, as noted previously, the methods described herein (e.g., process 1200 of FIG. 12, process 1300 of FIG. 13, process 1400 of FIG. 14 and/or other methods described herein) can be performed, in whole or in part, by a computing device or apparatus. In one example, one or more of the methods can be performed by system 200 of FIG. 2, modifier 210 of FIG. 2, FIG. 3, FIG. 4, FIG. 5, FIG. 7, and FIG. 10, system 300 of FIG. 3, system 400, of FIG. 4, or by another system or device. In another example, one or more of the methods (e.g., process 1200, process 1300, process 1400, and/or other methods described herein) can be performed, in whole or in part, by the computing-device architecture 1700 shown in FIG. 17. For instance, a computing device with the computing-device architecture 1700 shown in FIG. 17 can include, or be included in, the components of the system 200, modifier 210, system 300, and/or system 400, and can implement the operations of process 1200, process 1300, process 1400, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1200, process 1300, process 1400, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1200, process 1300, process 1400, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

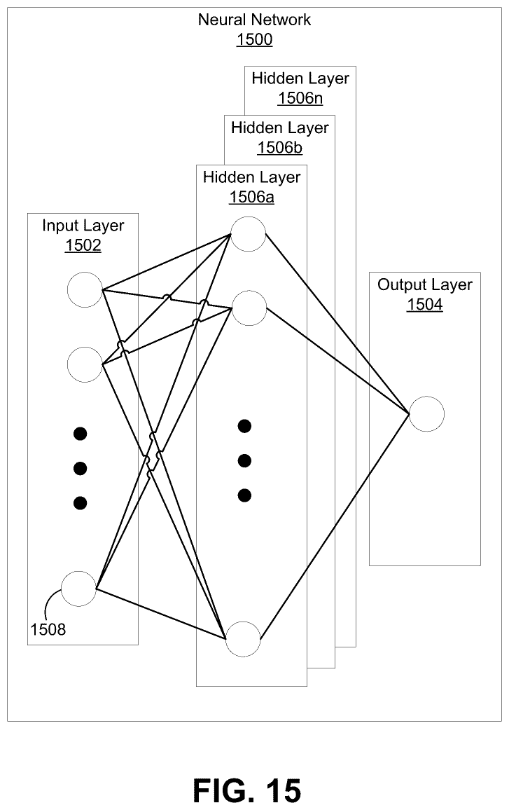

FIG. 15 is an illustrative example of a neural network 1500 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1500 may be an example of, or can implement, model generator 206 of FIG. 2, FIG. 3, and FIG. 4, body-pixel identifier 302 of FIG. 3 and FIG. 4, segment identifier 306, of FIG. 3 and FIG. 4, 3D data generator 310 of FIG. 3 and FIG. 4.

An input layer 1502 includes input data. In one illustrative example, input layer 1502 can include data representing image 204 of FIG. 2, FIG. 3, and FIG. 4. Neural network 1500 includes multiple hidden layers, for example, hidden layers 1506a, 1506b, through 1506n. The hidden layers 1506a, 1506b, through hidden layer 1506n include “n” number of hidden layers, where “n” is an integer greater than or equal to one. The number of hidden layers can be made to include as many layers as needed for the given application. Neural network 1500 further includes an output layer 1504 that provides an output resulting from the processing performed by the hidden layers 1506a, 1506b, through 1506n. In one illustrative example, output layer 1504 can provide 3D model 208 of FIG. 2, FIG. 3, and FIG. 4, body pixels 304 of FIG. 3 and FIG. 5, segments 308 of FIG. 3, FIG. 5, and FIG. 7, and 3D data 312 of FIG. 3, FIG. 5, FIG. 7, and FIG. 10.

Neural network 1500 may be, or may include, a multi-layer neural network of interconnected nodes. Each node can represent a piece of information. Information associated with the nodes is shared among the different layers and each layer retains information as information is processed. In some cases, neural network 1500 can include a feed-forward network, in which case there are no feedback connections where outputs of the network are fed back into itself. In some cases, neural network 1500 can include a recurrent neural network, which can have loops that allow information to be carried across nodes while reading in input.

Information can be exchanged between nodes through node-to-node interconnections between the various layers. Nodes of input layer 1502 can activate a set of nodes in the first hidden layer 1506a. For example, as shown, each of the input nodes of input layer 1502 is connected to each of the nodes of the first hidden layer 1506a. The nodes of first hidden layer 1506a can transform the information of each input node by applying activation functions to the input node information. The information derived from the transformation can then be passed to and can activate the nodes of the next hidden layer 1506b, which can perform their own designated functions. Example functions include convolutional, up-sampling, data transformation, and/or any other suitable functions. The output of the hidden layer 1506b can then activate nodes of the next hidden layer, and so on. The output of the last hidden layer 1506n can activate one or more nodes of the output layer 1504, at which an output is provided. In some cases, while nodes (e.g., node 1508) in neural network 1500 are shown as having multiple output lines, a node has a single output and all lines shown as being output from a node represent the same output value.

In some cases, each node or interconnection between nodes can have a weight that is a set of parameters derived from the training of neural network 1500. Once neural network 1500 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1500 to be adaptive to inputs and able to learn as more and more data is processed.

Neural network 1500 may be pre-trained to process the features from the data in the input layer 1502 using the different hidden layers 1506a, 1506b, through 1506n in order to provide the output through the output layer 1504. In an example in which neural network 1500 is used to identify features in images, neural network 1500 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1500 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1500 is trained well enough so that the weights of the layers are accurately tuned.

For the example of identifying objects in images, the forward pass can include passing a training image through neural network 1500. The weights are initially randomized before neural network 1500 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1500, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1500 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1500 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1500 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1500 can include any other deep network other than a CNN, such as an autoencoder, a deep belief nets (DBNs), a Recurrent Neural Networks (RNNs), among others.

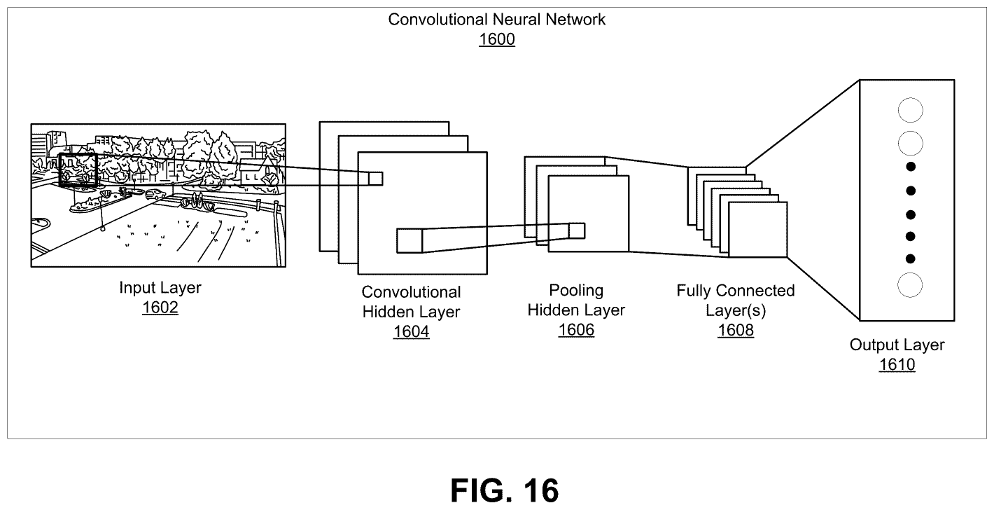

FIG. 16 is an illustrative example of a convolutional neural network (CNN) 1600. The input layer 1602 of the CNN 1600 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1604, an optional non-linear activation layer, a pooling hidden layer 1606, and fully connected layer 1608 (which fully connected layer 1608 can be hidden) to get an output at the output layer 1610. While only one of each hidden layer is shown in FIG. 16, one of ordinary skill will appreciate that multiple convolutional hidden layers, non-linear layers, pooling hidden layers, and/or fully connected layers can be included in the CNN 1600. As previously described, the output can indicate a single class of an object or can include a probability of classes that best describe the object in the image.

The first layer of the CNN 1600 can be the convolutional hidden layer 1604. The convolutional hidden layer 1604 can analyze image data of the input layer 1602. Each node of the convolutional hidden layer 1604 is connected to a region of nodes (pixels) of the input image called a receptive field. The convolutional hidden layer 1604 can be considered as one or more filters (each filter corresponding to a different activation or feature map), with each convolutional iteration of a filter being a node or neuron of the convolutional hidden layer 1604. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1604. Each connection between a node and a receptive field for that node learns a weight and, in some cases, an overall bias such that each node learns to analyze its particular local receptive field in the input image. Each node of the convolutional hidden layer 1604 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1604 is due to each node of the convolutional layer being applied to its corresponding receptive field. For example, a filter of the convolutional hidden layer 1604 can begin in the top-left corner of the input image array and can convolve around the input image. As noted above, each convolutional iteration of the filter can be considered a node or neuron of the convolutional hidden layer 1604. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1604. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1604.

The mapping from the input layer to the convolutional hidden layer 1604 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1604 can include several activation maps in order to identify multiple features in an image. The example shown in FIG. 16 includes three activation maps. Using three activation maps, the convolutional hidden layer 1604 can detect three different kinds of features, with each feature being detectable across the entire image.

In some examples, a non-linear hidden layer can be applied after the convolutional hidden layer 1604. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1600 without affecting the receptive fields of the convolutional hidden layer 1604.

The pooling hidden layer 1606 can be applied after the convolutional hidden layer 1604 (and after the non-linear hidden layer when used). The pooling hidden layer 1606 is used to simplify the information in the output from the convolutional hidden layer 1604. For example, the pooling hidden layer 1606 can take each activation map output from the convolutional hidden layer 1604 and generates a condensed activation map (or feature map) using a pooling function. Max-pooling is one example of a function performed by a pooling hidden layer. Other forms of pooling functions be used by the pooling hidden layer 1606, such as average pooling, L2-norm pooling, or other suitable pooling functions. A pooling function (e.g., a max-pooling filter, an L2-norm filter, or other suitable pooling filter) is applied to each activation map included in the convolutional hidden layer 1604. In the example shown in FIG. 16, three pooling filters are used for the three activation maps in the convolutional hidden layer 1604.

In some examples, max-pooling can be used by applying a max-pooling filter (e.g., having a size of 2×2) with a stride (e.g., equal to a dimension of the filter, such as a stride of 2) to an activation map output from the convolutional hidden layer 1604. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1604 having a dimension of 24×24 nodes, the output from the pooling hidden layer 1606 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1600.

The final layer of connections in the network is a fully-connected layer that connects every node from the pooling hidden layer 1606 to every one of the output nodes in the output layer 1610. Using the example above, the input layer includes 28×28 nodes encoding the pixel intensities of the input image, the convolutional hidden layer 1604 includes 3×24×24 hidden feature nodes based on application of a 5×5 local receptive field (for the filters) to three activation maps, and the pooling hidden layer 1606 includes a layer of 3×12×12 hidden feature nodes based on application of max-pooling filter to 2×2 regions across each of the three feature maps. Extending this example, the output layer 1610 can include ten output nodes. In such an example, every node of the 3×12×12 pooling hidden layer 1606 is connected to every node of the output layer 1610.

The fully connected layer 1608 can obtain the output of the previous pooling hidden layer 1606 (which should represent the activation maps of high-level features) and determines the features that most correlate to a particular class. For example, the fully connected layer 1608 can determine the high-level features that most strongly correlate to a particular class and can include weights (nodes) for the high-level features. A product can be computed between the weights of the fully connected layer 1608 and the pooling hidden layer 1606 to obtain probabilities for the different classes. For example, if the CNN 1600 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1610 can include an M-dimensional vector (in the prior example, M=10). M indicates the number of classes that the CNN 1600 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 17 illustrates an example computing-device architecture 1700 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1700 may include, implement, or be included in any or all of system 200 of FIG. 2, modifier 210 of FIG. 2, FIG. 3, FIG. 4, FIG. 5, FIG. 7, and FIG. 10, system 300 of FIG. 3, system 400, of FIG. 4 and/or other devices, modules, or systems described herein. Additionally or alternatively, computing-device architecture 1700 may be configured to perform process 1200, process 1300, process 1400, and/or other process described herein.

The components of computing-device architecture 1700 are shown in electrical communication with each other using connection 1712, such as a bus. The example computing-device architecture 1700 includes a processing unit (CPU or processor) 1702 and computing device connection 1712 that couples various computing device components including computing device memory 1710, such as read only memory (ROM) 1708 and random-access memory (RAM) 1706, to processor 1702.

Computing-device architecture 1700 can include a cache of high-speed memory connected directly with, in close proximity to, or integrated as part of processor 1702. Computing-device architecture 1700 can copy data from memory 1710 and/or the storage device 1714 to cache 1704 for quick access by processor 1702. In this way, the cache can provide a performance boost that avoids processor 1702 delays while waiting for data. These and other modules can control or be configured to control processor 1702 to perform various actions. Other computing device memory 1710 may be available for use as well. Memory 1710 can include multiple different types of memory with different performance characteristics. Processor 1702 can include any general-purpose processor and a hardware or software service, such as service 1 1716, service 2 1718, and service 3 1720 stored in storage device 1714, configured to control processor 1702 as well as a special-purpose processor where software instructions are incorporated into the processor design. Processor 1702 may be a self-contained system, containing multiple cores or processors, a bus, memory controller, cache, etc. A multi-core processor may be symmetric or asymmetric.

To enable user interaction with the computing-device architecture 1700, input device 1722 can represent any number of input mechanisms, such as a microphone for speech, a touch-sensitive screen for gesture or graphical input, keyboard, mouse, motion input, speech and so forth. Output device 1724 can also be one or more of a number of output mechanisms known to those of skill in the art, such as a display, projector, television, speaker device, etc. In some instances, multimodal computing devices can enable a user to provide multiple types of input to communicate with computing-device architecture 1700. Communication interface 1726 can generally govern and manage the user input and computing device output. There is no restriction on operating on any particular hardware arrangement and therefore the basic features here may easily be substituted for improved hardware or firmware arrangements as they are developed.

Storage device 1714 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1706, read only memory (ROM) 1708, and hybrids thereof. Storage device 1714 can include services 1716, 1718, and 1720 for controlling processor 1702. Other hardware or software modules are contemplated. Storage device 1714 can be connected to the computing device connection 1712. In one aspect, a hardware module that performs a particular function can include the software component stored in a computer-readable medium in connection with the necessary hardware components, such as processor 1702, connection 1712, output device 1724, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B” and‘ so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for human-body-model shape modification, the apparatus comprising: at least one memory; and at least one processor coupled to the at least one memory and configured to: obtain a three-dimensional (3D) model of a body of a person; obtain body pixels based on an image of the body of the person; generate projected body points by projecting points of the 3D model into an image plane; determine a body-point loss based on a comparison of the body pixels and the projected body points; and modify the 3D model based on the body-point loss to generate a first modified 3D model.

Aspect 2. The apparatus of aspect 1, wherein the at least one processor is configured to process the image using a machine-learning model to generate the 3D model of the body, wherein the 3D model comprises a Skinned Multi-Person Linear (SMPL) model.

Aspect 3. The apparatus of any one of aspects 1 or 2, wherein the at least one processor is configured to process the image using a machine-learning model to identify the body pixels based on the image.

Aspect 4. The apparatus of any one of aspects 1 to 3, wherein the points of the 3D model comprise joints, wherein the projected body points comprise projected joint points, and wherein the body pixels comprise joint pixels.

Aspect 5. The apparatus of any one of aspects 1 to 4, wherein the points of the 3D model comprise landmarks, wherein the projected body points comprise projected landmark points, and wherein the body pixels comprise landmark pixels.

Aspect 6. The apparatus of any one of aspects 1 to 5, wherein the at least one processor is configured to: obtain a segment identifier indicative of pixels of the image that relate to the body of the person; project vertices of the first modified 3D model into the image plane to generate projected vertices; determine a segment loss based on a comparison of the segment identifier and the projected vertices; and modify the first modified 3D model based on the segment loss to generate a second modified 3D model.

Aspect 7. The apparatus of aspect 6, wherein the projected body points comprise first projected body points, and wherein the body-point loss comprises a first body-point loss, wherein the at least one processor is configured to: project points of the first modified 3D model into the image plane to generate second projected body points; and determine a second body-point loss based on a comparison between the body pixels and the second projected body points, wherein the first modified 3D model is modified based on the segment loss and the second body-point loss.

Aspect 8. The apparatus of any one of aspects 6 or 7, wherein the at least one processor is configured to process the image using a machine-learning model to generate the segment identifier, wherein the segment identifier comprises a silhouette.

Aspect 9. The apparatus of any one of aspects 6 to 8, wherein the at least one processor is configured to: obtain 3D data based on the image; render the second modified 3D model to generate rendered 3D data; determine a 3D loss based on a comparison between the 3D data and the rendered 3D data; and modify the second modified 3D model based on the 3D loss to generate a third modified 3D model.

Aspect 10. The apparatus of aspect 9, wherein the projected body points comprise first projected body points, wherein the body-point loss comprises a first body-point loss, wherein the projected vertices comprise first projected vertices, and wherein the segment loss comprises a first segment loss, wherein the at least one processor is configured to: project points of the first modified 3D model into the image plane to generate second projected body points; determine a second body-point loss based on a comparison between the body pixels and the second projected body points, wherein the first modified 3D model is modified based on the segment loss and the second body-point loss; project points of the second modified 3D model into the image plane to generate third projected body points; determine a third body-point loss based on a comparison between the body pixels and the third projected body points; project vertices of the second modified 3D model into the image plane to generate second projected vertices; and determine a second segment loss based on a comparison between the segment identifier and the second projected vertices, wherein the second modified 3D model is modified based on the 3D loss, the third body-point loss, and the second segment loss.

Aspect 11. The apparatus of any one of aspects 9 or 10, wherein the at least one processor is configured to process the image using a machine-learning model to generate the 3D data related to the image.

Aspect 12. The apparatus of any one of aspects 9 to 11, wherein the 3D data comprises a depth map comprising distances between a camera which captured the image and points of the body of the person.

Aspect 13. The apparatus of any one of aspects 9 to 12, wherein the 3D data comprises a normal map comprising normal vectors for points of the body of the person.

Aspect 14. The apparatus of any one of aspects 9 to 13, wherein the at least one processor is configured to: obtain a plurality of images of the body of the person; select the image from among the plurality of images; process the image to generate the 3D model of the body; process the image to identify the body pixels based on the image; process the image to generate the segment identifier; and process the image to generate the 3D data related to the image.

Aspect 15. The apparatus of aspect 14, wherein the image is selected based on a pose of the person in the image.

Aspect 16. The apparatus of any one of aspects 14 or 15, wherein the at least one processor is configured to: select a second image from among the plurality of images; and modify the third modified 3D model based on the second image.

Aspect 17. The apparatus of any one of aspects 1 to 16, wherein the at least one processor is configured to: obtain a plurality of images of the body of the person; select the image from among the plurality of images; and modify the 3D model based on the plurality of images.

Aspect 18. The apparatus of aspect 17, wherein: to modify the 3D model based on the plurality of images the at least one processor is configured to modify multiple instances of the 3D model; wherein the multiple instances of the 3D model share a body shape; and wherein the multiple instances of the 3D model have respective body poses and respective translations.

Aspect 19. The apparatus of any one of aspects 1 to 18, wherein the 3D model is modified according to a gradient-descent technique.

Aspect 20. A method for human-body-model shape modification, the method comprising: obtaining a three-dimensional (3D) model of a body of a person; obtaining body pixels based on an image of the body of the person; generating projected body points by projecting points of the 3D model into an image plane; determining a body-point loss based on a comparison of the body pixels and the projected body points; and modifying the 3D model based on the body-point loss to generate a first modified 3D model.

Aspect 21. The method of aspect 20, further comprising processing the image using a machine-learning model to generate the 3D model of the body, wherein the 3D model comprises a Skinned Multi-Person Linear (SMPL) model.

Aspect 22. The method of any one of aspects 20 or 21, further comprising processing the image using a machine-learning model to identify the body pixels based on the image.

Aspect 23. The method of any one of aspects 20 to 22, wherein the points of the 3D model comprise joints, wherein the projected body points comprise projected joint points, and wherein the body pixels comprise joint pixels.

Aspect 24. The method of any one of aspects 20 to 23, wherein the points of the 3D model comprise landmarks, wherein the projected body points comprise projected landmark points, and wherein the body pixels comprise landmark pixels.

Aspect 25. The method of any one of aspects 20 to 24, further comprising: obtaining a segment identifier indicative of pixels of the image that relate to the body of the person; projecting vertices of the first modified 3D model into the image plane to generate projected vertices; determining a segment loss based on a comparison of the segment identifier and the projected vertices; and modifying the first modified 3D model based on the segment loss to generate a second modified 3D model.

Aspect 26. The method of aspect 25, wherein the projected body points comprise first projected body points, and wherein the body-point loss comprises a first body-point loss, the method further comprising: projecting points of the first modified 3D model into the image plane to generate second projected body points; and determining a second body-point loss based on a comparison between the body pixels and the second projected body points, wherein the first modified 3D model is modified based on the segment loss and the second body-point loss.

Aspect 27. The method of any one of aspects 25 or 26, further comprising processing the image using a machine-learning model to generate the segment identifier, wherein the segment identifier comprises a silhouette.

Aspect 28. The method of any one of aspects 25 to 27, further comprising: obtaining 3D data based on the image; rendering the second modified 3D model to generate rendered 3D data; determining a 3D loss based on a comparison between the 3D data and the rendered 3D data; and modifying the second modified 3D model based on the 3D loss to generate a third modified 3D model.

Aspect 29. The method of aspect 28, wherein the projected body points comprise first projected body points, wherein the body-point loss comprises a first body-point loss, wherein the projected vertices comprise first projected vertices, and wherein the segment loss comprises a first segment loss, the method further comprising: projecting points of the first modified 3D model into the image plane to generate second projected body points; determining a second body-point loss based on a comparison between the body pixels and the second projected body points, wherein the first modified 3D model is modified based on the segment loss and the second body-point loss; projecting points of the second modified 3D model into the image plane to generate third projected body points; determining a third body-point loss based on a comparison between the body pixels and the third projected body points; projecting vertices of the second modified 3D model into the image plane to generate second projected vertices; and determining a second segment loss based on a comparison between the segment identifier and the second projected vertices, wherein the second modified 3D model is modified based on the 3D loss, the third body-point loss, and the second segment loss.

Aspect 30. The method of any one of aspects 28 or 29, further comprising processing the image using a machine-learning model to generate the 3D data related to the image.

Aspect 31. The method of any one of aspects 28 to 30, wherein the 3D data comprises a depth map comprising distances between a camera which captured the image and points of the body of the person.

Aspect 32. The method of any one of aspects 28 to 31, wherein the 3D data comprises a normal map comprising normal vectors for points of the body of the person.

Aspect 33. The method of any one of aspects 28 to 32, further comprising: obtaining a plurality of images of the body of the person; selecting the image from among the plurality of images; processing the image to generate the 3D model of the body; processing the image to identify the body pixels based on the image; processing the image to generate the segment identifier; and processing the image to generate the 3D data related to the image.

Aspect 34. The method of aspect 33, wherein the image is selected based on a pose of the person in the image.

Aspect 35. The method of any one of aspects 33 or 34, further comprising: selecting a second image from among the plurality of images; and modifying the third modified 3D model based on the second image.

Aspect 36. The method of any one of aspects 20 to 35, further comprising: obtaining a plurality of images of the body of the person; selecting the image from among the plurality of images; and modifying the 3D model based on the plurality of images.

Aspect 37. The method of aspect 36, wherein: modifying the 3D model based on the plurality of images comprises modifying multiple instances of the 3D model; wherein the multiple instances of the 3D model share a body shape; and wherein the multiple instances of the 3D model have respective body poses and respective translations.

Aspect 38. The method of any one of aspects 20 to 37, wherein the 3D model is modified according to a gradient-descent technique.

Aspect 39. A non-transitory computer-readable storage medium having stored thereon instructions that, when executed by at least one processor, cause the at least one processor to perform operations according to any of aspects 20 to 38.

Aspect 40. An apparatus for providing virtual content for display, the apparatus comprising one or more means for perform operations according to any of aspects 20 to 38.

What is claimed is:

1. An apparatus for human-body-model shape modification, the apparatus comprising:
at least one memory; and
at least one processor coupled to the at least one memory and configured to:
obtain a three-dimensional (3D) model of a body of a person;
obtain body pixels based on an image of the body of the person;
generate projected body points by projecting points of the 3D model into an image plane;
determine a body-point loss based on a comparison of the body pixels and the projected body points; and
modify the 3D model based on the body-point loss to generate a first modified 3D model.

2. The apparatus of claim 1, wherein the at least one processor is configured to process the image using a machine-learning model to generate the 3D model of the body, wherein the 3D model comprises a Skinned Multi-Person Linear (SMPL) model.

3. The apparatus of claim 1, wherein the at least one processor is configured to process the image using a machine-learning model to identify the body pixels based on the image.

4. The apparatus of claim 1, wherein the points of the 3D model comprise joints, wherein the projected body points comprise projected joint points, and wherein the body pixels comprise joint pixels.

5. The apparatus of claim 1, wherein the points of the 3D model comprise landmarks, wherein the projected body points comprise projected landmark points, and wherein the body pixels comprise landmark pixels.

6. The apparatus of claim 1, wherein the at least one processor is configured to:
obtain a segment identifier indicative of pixels of the image that relate to the body of the person;
project vertices of the first modified 3D model into the image plane to generate projected vertices;
determine a segment loss based on a comparison of the segment identifier and the projected vertices; and
modify the first modified 3D model based on the segment loss to generate a second modified 3D model.

7. The apparatus of claim 6, wherein the projected body points comprise first projected body points, and wherein the body-point loss comprises a first body-point loss, wherein the at least one processor is configured to:
project points of the first modified 3D model into the image plane to generate second projected body points; and
determine a second body-point loss based on a comparison between the body pixels and the second projected body points, wherein the first modified 3D model is modified based on the segment loss and the second body-point loss.

8. The apparatus of claim 6, wherein the at least one processor is configured to process the image using a machine-learning model to generate the segment identifier, wherein the segment identifier comprises a silhouette.

9. The apparatus of claim 6, wherein the at least one processor is configured to:
obtain 3D data based on the image;
render the second modified 3D model to generate rendered 3D data;
determine a 3D loss based on a comparison between the 3D data and the rendered 3D data; and
modify the second modified 3D model based on the 3D loss to generate a third modified 3D model.

10. The apparatus of claim 9, wherein the projected body points comprise first projected body points, wherein the body-point loss comprises a first body-point loss, wherein the projected vertices comprise first projected vertices, and wherein the segment loss comprises a first segment loss, wherein the at least one processor is configured to:
project points of the first modified 3D model into the image plane to generate second projected body points;
determine a second body-point loss based on a comparison between the body pixels and the second projected body points, wherein the first modified 3D model is modified based on the segment loss and the second body-point loss;
project points of the second modified 3D model into the image plane to generate third projected body points;
determine a third body-point loss based on a comparison between the body pixels and the third projected body points;
project vertices of the second modified 3D model into the image plane to generate second projected vertices; and
determine a second segment loss based on a comparison between the segment identifier and the second projected vertices, wherein the second modified 3D model is modified based on the 3D loss, the third body-point loss, and the second segment loss.

11. The apparatus of claim 9, wherein the at least one processor is configured to process the image using a machine-learning model to generate the 3D data related to the image.

12. The apparatus of claim 9, wherein the 3D data comprises a depth map comprising distances between a camera which captured the image and points of the body of the person.

13. The apparatus of claim 9, wherein the 3D data comprises a normal map comprising normal vectors for points of the body of the person.

14. The apparatus of claim 9, wherein the at least one processor is configured to:
obtain a plurality of images of the body of the person;
select the image from among the plurality of images;
process the image to generate the 3D model of the body;
process the image to identify the body pixels based on the image;
process the image to generate the segment identifier; and
process the image to generate the 3D data related to the image.

15. The apparatus of claim 14, wherein the image is selected based on a pose of the person in the image.

16. The apparatus of claim 14, wherein the at least one processor is configured to:
select a second image from among the plurality of images; and
modify the third modified 3D model based on the second image.

17. The apparatus of claim 1, wherein the at least one processor is configured to:
obtain a plurality of images of the body of the person;
select the image from among the plurality of images; and
modify the 3D model based on the plurality of images.

18. The apparatus of claim 17, wherein:
to modify the 3D model based on the plurality of images the at least one processor is configured to modify multiple instances of the 3D model;
wherein the multiple instances of the 3D model share a body shape; and
wherein the multiple instances of the 3D model have respective body poses and respective translations.

19. The apparatus of claim 1, wherein the 3D model is modified according to a gradient-descent technique.

20. A method for human-body-model shape modification, the method comprising:
obtaining a three-dimensional (3D) model of a body of a person;
obtaining body pixels based on an image of the body of the person;
generating projected body points by projecting points of the 3D model into an image plane;
determining a body-point loss based on a comparison of the body pixels and the projected body points; and
modifying the 3D model based on the body-point loss to generate a first modified 3D model.
